(19) United States
(12) Patent Application Publication
(10) Pub. No.: US 2009/0157781 A1
(43) Pub. Date: Jun. 18, 2009

(54) METHOD AND APPARATUS FOR GENERATING CONTENT IDENTIFIER AND PREVENTING ALTERATION OF THE CONTENT IDENTIFIER

(75) Inventors: So-young LEE, Hwaseong-si (KR); Ji-young MOON, Hwaseong-si (KR); Yang-lim CHOI, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/208,632

(22) Filed: Sep. 11, 2008

(30) Foreign Application Priority Data
Dec. 14, 2007 (KR) 10-2007-0131078

(51) Int. Cl. G06F 1/02

(52) U.S. Cl. 708/250

(57) ABSTRACT

A method and apparatus for generating a content identifier and preventing alteration of the content identifier are provided. The method includes generating at least one random number, generating location information for designating a plurality of locations within a content by using the at least one generated random number, extracting a plurality of parts of the content, which correspond to the generated location information, from the content, generating a integrity verification value based on the extracted parts of the content, which correspond to the generated location information, and generating the content identifier having the integrity verification value and the at least one generated random number.

### CROSS-REFERENCE TO RELATED PATENT APPLICATION

This application claims priority from Korean Patent Application No. 10-2007-0131078 filed on Dec. 14, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to generating a content identifier and more particularly, to generating a content identifier and preventing alteration of the content identifier.

2. Description of the Related Art

In order to effectively manage digitalized contents, content identifiers are necessary to identify the respective digitized contents. The content identifiers must respectively have their own values that are not duplicates of each other.

Also, the content identifiers are used to control the usage of the contents. For example, in order to prohibit the use of a content having a content identifier A, a rule prohibiting the use of the content having the content identifier A may be contained in metadata of the content.

However, even if the above-described rule is set, a malicious user may alter the content identifier A into a content identifier A′. In this case, the rule prohibiting the use of the content having the content identifier A does not apply to the content identifier A′ and thus the malicious user can illegally use the content. In order to prevent the illegal use of the contents, the content identifiers must not be easily altered.

Therefore, a variety of methods of generating a content identifier that prevents its alteration have been proposed.

In one proposed method, a value that is obtained by hashing all parts of the content is used as a content identifier. This proposed method, however, has a drawback in that it is time-consuming to calculate the hash value for all parts of the content.

In another proposed method, a value that is obtained by hashing a specific part of the content is used as a content identifier. This method, however, has a drawback in that the alteration is still possible if the specific part of the content is altered to a new value from which the content identifier is generated.

As described above, the prior art methods cannot effectively prevent the alteration of the content identifier.

### SUMMARY OF THE INVENTION

Provided are a method and apparatus for generating a content identifier so as to effectively prevent alteration of the content identifier.

According to an aspect of the present invention, there is provided a method of generating a content identifier and preventing alteration of the content identifier, the method including: generating at least one random number; generating location information for designating locations within a content by using the at least one generated random number; extracting parts of the content which correspond to the generated location information from the content; generating an integrity verification value based on the extracted parts of the content; and generating the content identifier having the integrity verification value and the at least one generated random number.

According to another aspect of the present invention, there is provided a method of determining alteration of a content identifier, including: receiving a content and a content identifier having a first integrity verification value for parts of the content, and at least one random number; extracting the first integrity verification value and at least one random number from the received content identifier; generating location information for designating locations within the content using the at least one extracted random number; extracting parts of the content which correspond to the generated location information from the received content; generating a second integrity verification value according to a method used for generating the first integrity verification value based on the extracted parts of the content; and determining if the received content identifier is altered by comparing the first integrity verification value with the second integrity verification value.

According to another aspect of the present invention, there is provided a content identifier generating apparatus for preventing alteration of the content identifier, the apparatus including: a random number generating unit for generating at least one random number; a location information generating unit for generating location information for designating locations within a content by using the at least one generated random number; an extracting unit for extracting parts of the content, which correspond to the location information; an integrity verification value generating unit for generating an integrity verification value based on the extracted parts of the content; and an identifier generating unit for generating the content identifier having the integrity verification value and the at least one generated random number.

According to another aspect of the present invention, there is provided an apparatus for determining alteration of a content identifier, the apparatus including: a receiving unit for receiving a content and a content identifier having a first integrity verification value for parts of the content, and at least one random number; an extracting unit for extracting the first integrity verification value and at least one random numbers from the received content identifier; a location information generating unit for generating location information for designating locations within the content by using the at least one extracted random number; a integrity verification value generating unit for, when the extracting unit extracts the parts of the content, which correspond to the location information, generating a second integrity verification value according to a method used for generating the first integrity verification value based on the extracted parts of the content; and a determining unit for determining if the received content identifier is altered by comparing the first integrity verification value with the second integrity verification value.

### BRIEF DESCRIPTION OF THE DRAWINGS

The above and other aspects of the present invention will become more apparent by describing in detail exemplary embodiments thereof with reference to the attached drawings in which:

FIG. 1 illustrates a block diagram of a content identifier generating apparatus for preventing alteration of the content identifier, according to an exemplary embodiment of the present invention;

FIG. 2 illustrates a content identifier according to an exemplary embodiment of the present invention;

FIG. 3 illustrates a method of generating a content identifier and preventing alteration of the content identifier, according to an exemplary embodiment of the present invention;

FIG. 4 is a flowchart illustrating a method of generating a content identifier and preventing alteration of the content identifier, according to an exemplary embodiment of the present invention;

FIG. 5 illustrates a content identifier alteration determining unit for a content identifier, according to an exemplary embodiment of the present invention;

FIG. 6 illustrates a method of determining content identifier alteration according to an exemplary embodiment of the present invention; and

FIG. 7 is a flowchart illustrating a method of determining content identifier alteration according to an exemplary embodiment of the present invention.

### DETAILED DESCRIPTION OF THE EXEMPLARY EMBODIMENTS

The present invention will now be described more fully with reference to the accompanying drawings, in which exemplary embodiments of the present invention are shown.

FIG. 1 illustrates a block diagram of a content identifier generating apparatus for preventing alteration of the content identifier, according to an exemplary embodiment of the present invention.

Referring to FIG. 1, the content identifier generating apparatus of the exemplary embodiment of the present invention includes a random number generating unit 110, a location information generating unit 120, an extracting unit 130, an integrity verification value generating unit 140, and an identifier generating unit 150.

The random number generating unit 110 generates at least one random number.

The location information generating unit 120 generates location information for assigning a plurality of locations in a content by using the generated random number.

For example, the location information may be an offset location of the content or may be a packet number when the content is formed as a packet. In more detail, the location information may be represented as, for example, a section of sixteen bytes from the 100^{th} offset of the content or a 9^{th} or 10^{th} packet among 100 packets of the content.

At this point, the location information generating unit 120 may generate the location information based on a location table containing a plurality of numbers and locations in the content which correspond to the generated random numbers.

For example, in the location table, a location corresponding to a number one is a section of sixteen bytes from the 100^{th} offset of the content and a location corresponding to a number two is a section of sixteen bytes from the 200^{th} offset of the content.

When the random number generated by the random number generating unit 100 is one, the location information generating unit 120 will generate location information designating a section of sixteen bytes from 100^{th} offset of the content based on the location table of the above example.

In addition, according to another example, the location information generating unit 120 may generate the location information using a location information function, which outputs a location information from a predetermined random number as an input, according to a predetermined calculation formula.

For example, when a random number one is input to the location information generating unit 120, the location information generating unit 120 may generate location information using the location information function such that a section of sixteen bytes from the 100^{th} offset of the content is designated.

In this case, since an operation is necessary, the location information generating time is longer as compared with a case where the table is used. Meanwhile, it is assumed that a part generating the content identifier shares the location table and the location information function with a part determining the generated content identifier alteration.

The extracting part 130 extracts a plurality of parts of the content, which correspond to the location information generated by the information generating unit 130.

The integrity verification value generating unit 140 generates an integrity verification value using the parts of the content which are extracted by the extracting unit 130.

At this point, the integrity verification value generating unit 140 may generate the integrity verification value by performing at least one of an exclusive OR-operation and a hash operation on the plurality of parts of the content which correspond to the respective locations. Also, the exclusive OR-operation may be performed before or after the hash operation is performed.

For example, the integrity verification value generating unit 140 generates hash values by performing the hash operation on the plurality of parts of the content, which correspond to the respective locations and subsequently uses the generated hash values to generate the content identifier.

However, such an integrity verification value generating method of the integrity verification value generating unit 140 is not limited to the exclusive OR-operation and the hash operation, and thus all of the methods of disallowing for the direct identification of data contained in the parts of the content may be used.

The identifier generating unit 150 generates a content identifier containing the integrity verification value generated by the integrity verification value generating unit 140 and at least one random number generated by the random number generating unit 1 10.

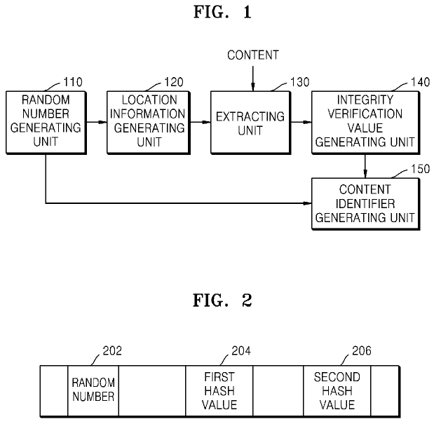

FIG. 2 illustrates the content identifier according to an exemplary embodiment of the present invention.

FIG. 2 shows an example where there are integrity verification values 204 and 206 (hereinafter respectively referred to as a ‘first hash value 204’ and a ‘second hash value 206’). Referring to FIG. 2, the content identifier has a random number 202, a first hash value 204, and a second hash value 206. The first and second hash values 204 and 206 may be spaced apart from each other as shown in FIG. 2 or disposed adjacent to each other.

In the exemplary embodiment, the first and second hash values 204 and 206 are obtained by performing a hash operation for two parts of the content. However, although the hash operation is used to generate the integrity verification values in this exemplary embodiment, other methods for disallowing for the direct identification of data contained in the parts of the content may be also used to generate the integrity verification values.

In another example, an exclusive OR-operation for the integrity verification values generated through the hash operation may be further performed to generate one integrity verification value. Alternatively, after the exclusive OR-operation for the parts of the content is performed, the hash operation for the values obtained through the exclusive OR-operation may be performed to generate one integrity verification value.

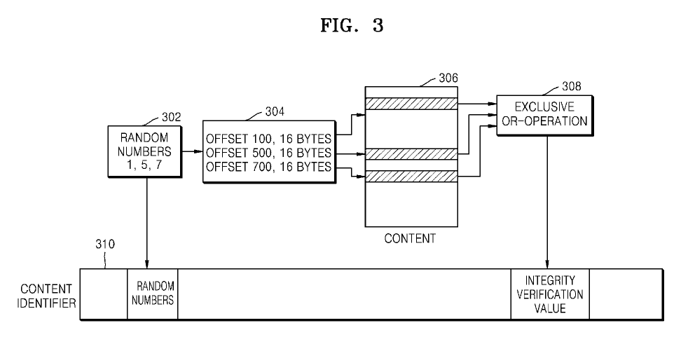

FIG. 3 illustrates a method of generating a content identifier and preventing alteration of the content identifier, according to an exemplary embodiment of the present invention.

Referring to FIG. 3, the random number generating unit 110 generates random numbers one, five, and seven (302).

Next, the location information generating unit 120 generates location information designating a section of sixteen bytes from the 100^{th} offset, a section of sixteen bytes from the 500^{th} offset, and a section of sixteen bytes from the 700^{th} offset in response to the random numbers one, five, and seven (304).

Next, the extracting unit 130 extracts parts of the content, which correspond to the locations of the respective sections of the sixteen bytes from the 100^{th}, 500^{th}, and 700^{th} offsets (306).

Next, the integrity verification value generating unit 140 performs an exclusive OR-operation for the parts of the content, which are extracted by the extracting part 130 (308).

As described above, the integrity verification value generating unit 140 performs the exclusive OR-operation for the parts of the content and subsequently further performs the hash operation.

Next, the identifier generating unit 150 generates a content identifier having the random numbers one, five, and seven, and the parts of the content for which the exclusive OR-operation is performed (310).

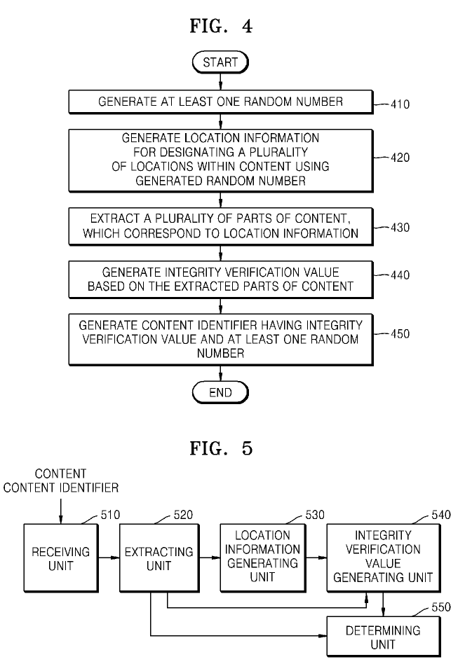

FIG. 4 is a flowchart illustrating a method of generating a content identifier and preventing alteration of the content identifier, according to an exemplary embodiment of the present invention.

Referring to FIG. 4, at least one random number is first generated (410).

Next, location information for designating a plurality of locations in the content using the at least one generated random number is generated (420).

Subsequently, parts of the content, which correspond to the location information, are extracted from the content (430).

Next, an integrity verification value is generated based on the extracted parts of the content (440).

Subsequently, a content identifier having the integrity verification value and at least one random number is generated (450).

The following will describe a method of determining alteration of the content identifier generated by the above-described content identifier generating method.

FIG. 5 illustrates a content identifier alteration determining unit for a content identifier, according to an exemplary embodiment of the present invention.

Referring to FIG. 5, the content identifier alteration determining unit includes a receiving unit 510 that receives a content and a content identifier having a first integrity verification value that is generated based on a plurality of parts of the content and at least one random number. At this point, the content identifier is an identifier corresponding to the content.

Also, at least one random number contained in the content identifier is used to generate the location information that is necessary for extracting the parts of the content, which are used to generate the first integrity verification value.

In addition, the receiving unit 510 can receive metadata which include the content identifier. At this point, the metadata may include control information for controlling the use of the content corresponding to the content identifier contained in the metadata. In this case, the use of the content may be controlled in accordance with the control information.

In addition, the metadata may include a content identifier corresponding to a content that will be encrypted. In this case, the encrypting of the content corresponding to the content identifier can be performed based on the content identifier contained in the metadata.

Also, the receiving unit 510 may receive the content and metadata from one server, or from a content server and a metadata server.

Once the content and the content identifier are received by the receiving unit 510, the received content and content identifier may be independently stored from each other. Alternatively, the receive content and content identifier may be stored such that the content identifier is contained in a header of the content.

An extracting unit 520 extracts the first integrity verification value and at least one random number from the content identifier received by the receiving unit 510.

A location information generating unit 530 generates location information for designating a plurality of locations in the content using at least one random number extracted by the extracting unit 520.

At this point, the location information generated by the location information generating unit 530 must be structured to have an output value identical to that of the location information generating unit 120 of the above-described content identifier generating apparatus when their input values are identical.

When the location information generating unit 530 generates the location information as described above, the location information may be generated based on a location table or a location information function. At this point, the location table and the location information function must be identical to those used in the content identifier generating apparatus.

When the extracting unit 520 extracts the parts of the content, which correspond to the location information, an integrity verification value generating unit 540 generates a second integrity verification value in accordance with the method used for generating the first integrity verification value.

For example, if the first integrity verification value is generated through the exclusive OR-operation, the integrity verification value generating unit 540 generates the second integrity verification value by performing the exclusive OR-operation for the parts extracted from the content.

A determining unit 550 determines alteration of the content identifier received by the receiving unit 410 by comparing the first integrity verification value extracted from the content identifier with the second integrity verification value generated by the integrity verification value generating unit 540.

At this point, if the first integrity verification value is identical to the second integrity verification value, a determining unit 550 determines that the content identifier is not altered. Otherwise, if the first integrity verification value is not identical to the second integrity verification, the determining unit 550 determines that the content identifier is altered.

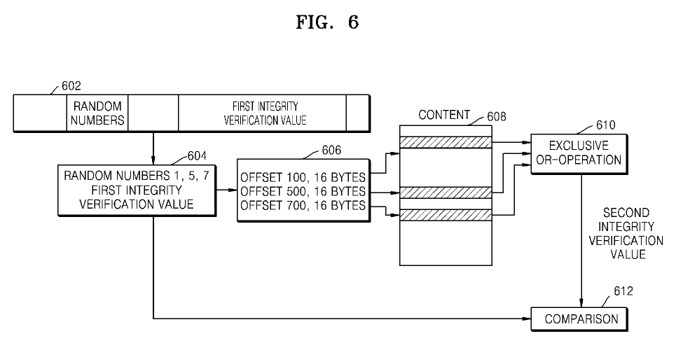

FIG. 6 illustrates a method of determining content identifier alteration according to an exemplary embodiment of the present invention.

First, the receiving unit 510 receives the content and the content identifier (602). For descriptive convenience, only the content identifier is illustrated in Step 602.

Next, the extracting unit 520 extracts the random numbers (e.g., one, five, and seven) and the first integrity verification value from the content identifier (604).

Subsequently, the location information generating unit 530 generates location information designating a section of sixteen bytes from the 100^{th} offset, a section of sixteen bytes from the 500^{th} offset, and a section of sixteen bytes from the 700^{th} offset in response to the random numbers one, five, and seven (606).

At this point, if the input is identical, the location information generating unit 530 must be designed to form an identical output to the location information generating unit 120 of the content identifier generating apparatus depicted in FIG. 3. Therefore, the inputs of FIG. 5 are the random numbers one, five, and seven which are identical to those of FIG. 3. The location information that is the output of the location information generating unit 530 is also generated to designate a section of sixteen bytes from the 100^{th} offset, a section of sixteen bytes from the 500^{th} offset, and a section of sixteen bytes from the 700^{th} offset in response to the random numbers one, five, and seven.

Next, the extracting unit 520 extracts parts of the content, which correspond to the section of sixteen bytes from the 100^{th} offset, the section of sixteen bytes from the 500^{th} offset, and the section of sixteen bytes from the 700^{th} offset (608).

Subsequently, the integrity verification value generating unit 540 generates the second integrity verification value by performing the exclusive OR-operation for the parts of the content, which are extracted by the extracting unit 520 (610).

Here, the reason for performing the exclusive OR-operation when generating the second integrity verification value is that the first integrity verification value is generated through the exclusive OR-operation. If the first integrity verification value is formed with the hash value, the second integrity verification value must be also formed with the hash value for the parts of the content.

Next, the determining unit 550 determines alteration of the content identifier received in operation 602 by comparing the first integrity verification value extracted in operation 604 with the second integrity verification value generated in operation 610 (612).

The content identifier alteration determining method of this exemplary embodiment may be used to control the use of the content. For example, if it is determined that the content identifier is altered, the use of the content corresponding to the altered content identifier can be prohibited. If necessary, even when the content identifier is not altered and thus the use of the content is allowed, the use of the content may be prohibited if the information for controlling the use of the content is contained in the metadata.

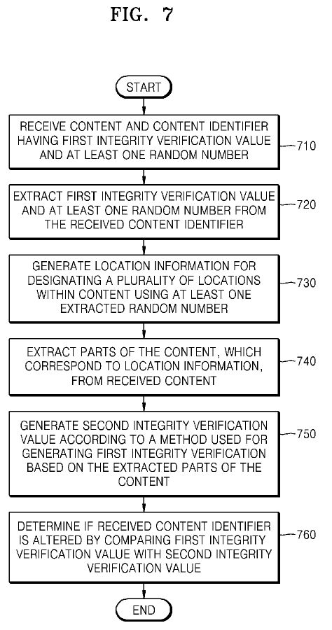

FIG. 7 is a flowchart illustrating a method of determining content identifier alteration according to an exemplary embodiment of the present invention.

First, a content and a content identifier having a first integrity verification value generated based on a plurality of parts of the content and at least one random number are received (710).

Next, the first integrity verification value and at least one random number are extracted from the received content identifier (720).

Subsequently, the location information for designating locations within the content is generated using at least one extracted random number (740).

Next, the second integrity verification value is generated using the method used for generating the first integrity verification value based on the extracted parts of the content (750).

Subsequently, it is determined whether the content identifier is altered by comparing the first integrity verification value with the second integrity verification value (760).

According to exemplary embodiments of the present invention, alteration of a content identifier can be effectively prevented by generating at least one random number, generating location information designating a plurality of locations within the content using at least one random number, extracting a plurality of parts of the content, which correspond to the generated location information, from the content, generating a integrity verification value based on the extracted parts of the content, and generating the content identifier having the integrity verification value and at least one random number.

Also, the present invention can also be embodied as computer readable medium storing thereon a computer program making a computer perform the computer program.

The computer readable recording medium is any data storage device that can store data, which can be thereafter read by a computer system. Examples of the computer readable recording medium include read-only memory (ROM), random-access memory (RAM), CD-ROMs, magnetic tapes, floppy disks, and optical data storage devices.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of generating a content identifier and preventing alteration of the content identifier, the method comprising:
generating at least one random number;
generating location information for designating a plurality of locations within a content by using the at least one random number;
extracting a plurality of parts of the content which correspond to the location information;
generating an integrity verification value based on the plurality of parts of the content; and
generating the content identifier comprising the integrity verification value and the at least one random number.

2. The method of claim 1, wherein the generating the integrity verification value comprises performing at least one of an exclusive OR-operation and a hash operation on the plurality of parts of the content.

3. The method of claim 1, wherein the location information is generated based on a location table comprising a plurality of numbers and locations within the content corresponding to the at least one random number.

4. The method of claim 1, wherein the location information comprises an offset location of the content or a packet number if the content comprises packets.

5. A method of determining alteration of a content identifier, the method comprising:
receiving a content;
receiving a content identifier comprising:
a first integrity verification value for a plurality of parts of the content, and
at least one random number;
extracting the first integrity verification value and the at least one random number from the content identifier;
generating location information for designating a plurality of locations within the content using the at least one random number;
extracting a plurality of parts of the content, which correspond to the location information;
generating a second integrity verification value according to a method used for generating the first integrity verification value based on the plurality of parts of the content; and
determining whether the content identifier is altered by comparing the first integrity verification value with the second integrity verification value.

6. The method of claim 5, further comprising receiving metadata, wherein the metadata comprises:
the content identifier, and
control information for controlling use of the content corresponding to the content identifier.

7. The method of claim 5, wherein the location information is generated based on a location table comprising a plurality of numbers and locations within the content corresponding to the at least one random number.

8. A content identifier generating apparatus for preventing alteration of the content identifier, the apparatus comprising:
a random number generating unit which generates at least one random number;
a location information generating unit which generates location information, wherein the location information designates a plurality of locations within a content by using the at least one random number;
an extracting unit which extracts a plurality of parts of the content corresponding to the location information;
an integrity verification value generating unit which generates an integrity verification value based on the plurality of parts of the content; and
an identifier generating unit which generates the content identifier, wherein the content identifier comprises:
the integrity verification value, and
the at least one random number.

9. The content identifier generating apparatus of claim 8, wherein the integrity verification value generating unit generates the integrity verification value by performing at least one of an exclusive OR-operation and a hash operation for the plurality of parts of the content.

10. The content identifier generating apparatus of claim 8, wherein the location information generating unit generates the location information based on a location table containing a plurality of numbers and locations within the content corresponding to the at least one random number.

11. The content identifier generating apparatus of claim 8, wherein the location information comprises an offset location of the content or a packet number if the content comprises packets.

12. An apparatus for determining alteration of a content identifier, the apparatus comprising:
a receiving unit which receives a content and a content identifier comprising:
a first integrity verification value for a plurality of parts of the content, and
at least one random number;
an extracting unit which extracts the first integrity verification value and the at least one random number from the content identifier;
a location information generating unit which generates location information, wherein the location information designates a plurality of locations within the content by using the at least one random number;
an integrity verification value generating unit which generates a second integrity verification value according to a method used for generating the first integrity verification value based on an extracted parts of the content, wherein the extracted parts of the content correspond to the location information and are extracted by the extracting unit; and
a determining unit which determines whether the received content identifier is altered by comparing the first integrity verification value with the second integrity verification value.

13. The apparatus of claim 12, wherein the receiving unit receives metadata comprising:
the content identifier, and
control information which controls use of the content corresponding to the content identifier.

14. The apparatus of claim 12, wherein the location information is generated based on a location table comprising a plurality of numbers and locations within the content corresponding to the at least one random number.

15. A computer readable medium storing thereon a computer program making a computer perform the method of claim 1.
